(19) United States
(12) Patent Application Publication
(10) Pub. No.: US 2025/0257987 A1
(43) Pub. Date: Aug. 14, 2025

(54) Marking Tool Holder Device for Tape Measure

(71) Applicant: Conroy E. Carridice, Riviera Beach, FL (US)

(72) Inventor: Conroy E. Carridice, Riviera Beach, FL (US)

(21) Appl. No.: 18/735,974

(22) Filed: Jun. 6, 2024

Related U.S. Application Data
(60) Provisional application No. 63/506,382, filed on Jun. 6, 2023.

(51) Int. Cl. G01B 3/1089; G01B 3/1056

(52) U.S. Cl. CPC G01B 3/1089; G01B 3/1056

(57) ABSTRACT

A tape measure marking tool holder device. The device includes a clip that securely accommodates the hook of a conventional tape measure. The clip includes a pair of parallel walls with a slit disposed therebetween for holding a tape measure hook. In one embodiment, the clip has a magnetic base for securing the bottom edge of the hook. In other embodiments, the bottom edge of the hook is integrated into the clip. A horizontal hollow cylinder is integrated underneath the clip and is designed to snugly hold a marking utensil (i.e., a pencil), obviating the need to fumble for a separate tool, or reaching in a pocket, or reaching behind the ear to access the marking utensil. The cylinder can have different shapes to accommodate different types of pencils or marking utensils.

### CROSS-REFERENCE TO RELATED APPLICATION

The present application claims priority to, and the benefit of, U.S. Provisional Application No. 63/506,382, which was filed on Jun. 6, 2023, and is incorporated herein by reference in its entirety.

### FIELD OF THE INVENTION

The present invention generally relates to the field of tape measures. More specifically, the present invention relates to a novel tape measure attachment device for holding a marking tool for marking on different surfaces and items. The device includes a clip having a slit disposed between two walls for accommodating and securing a tape measure hook. Directly underneath the clip portion is a horizontal cylinder to receive a marking utensil such as a small pencil. The pencil can be used for marking a mark while the tape measure is used for measuring items and distances. Accordingly, the present disclosure makes specific reference thereto. Nonetheless, it is to be appreciated that aspects of the present invention are also equally applicable to other like applications, devices, and methods of manufacture.

### BACKGROUND

By way of background, a tape measure is a device commonly used by carpenters, painters, DIY professionals, and more for making measurements on different surfaces and items. It is common for individuals to make markings on the materials being measured. The markings are essential for various tasks, such as making cuts, measuring distances between points, or indicating specific locations for further work. Generally, to make these markings, individuals need a marking utensil, such as a small pencil. Further, individuals frequently have to reach into their pockets or behind their ear to retrieve the marking utensil. The constant back-and-forth to retrieve the marking utensil can disrupt the workflow and slow down the measurement process. Also, as individuals repeatedly remove the pencil, they may accidentally drop the pencil during the measurement process. This can lead to inaccuracies in measurements and potentially damage to materials. Another challenge is the potential for misplacing or forgetting the pencil. It is common for people to leave pencils at the work site or misplaced among tools and materials, causing frustration and delays.

Individuals may need to bend, kneel, or assume uncomfortable positions to access and use their marking utensil in tight or confined spaces. This not only affects comfort but can also impact the accuracy of the markings. People desire a device that addresses the issues of convenience, the risk of dropping the pencil, and the potential for misplacement of a marking utensil used with a tape measure.

Therefore, there exists a long-felt need in the art for a tape measure attachment device that eliminates the need for individuals to carry the pencil separately in their pockets or behind their ear while using a tape measure. Additionally, there is a long-felt need in the art for a tape measure attachment device that can be integrated or detachably attached to a hook of a tape measure. Moreover, there is a long-felt need in the art for a tape measure marking utensil holder device that provides easy accessibility of the marking utensil to an individual working with the tape measure. Further, there is a long-felt need in the art for a tape measure attachment device that makes measurements and markings more efficient and less prone to disruptions. Furthermore, there is a long-felt need in the art for a tape measure accessory device that enables individuals to make markings with ease, even in tight spaces. Finally, there is a long-felt need in the art for a tape measure marking utensil holder device that prevents individuals from accidentally dropping or losing track of their marking utensil.

The subject matter disclosed and claimed herein, in one embodiment thereof, comprises a tape measure marking tool holder device. The device is attached to a hook of a tape measure for holding a marking utensil. The device features a tape measure hook accommodating clip and an integrated horizontal hollow cylinder. The tape measure hook accommodating clip is disposed atop the horizontal hollow cylinder. The tape measure hook accommodating clip includes a first wall and a second wall, and a slit is formed therebetween. The slit is adapted to accommodate the tape measure hook and a magnetic base of the clip secures the bottom edge of the hook to prevent unintentional disengagement of the hook from the cavity. The cylinder has a first open end and a second open end opposite the first open end, with a continuous cavity extending along the length of the cylinder between the open ends. The cylinder is adapted for accommodating a marking utensil such as a small pencil in a horizontal position enabling a user to utilize the marking utensil for making a mark on a surface.

In this manner, the tape measure marking tool holder device of the present invention accomplishes all of the foregoing objectives and provides users with an attachment for the hook of a tape measure to hold a marking utensil in place to make it easy for the user to make markings. The device is secured to the hook and holds a marking tool, thus, obviating the need to stop to reach for a marking pencil while measuring. The marking utensil remains secured and prevents individuals from accidentally dropping or losing track of their marking utensil.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tape measure marking tool holder device. The device further comprising a tape measure hook accommodating clip and a horizontal hollow cylinder. The tape measure hook accommodating clip is disposed atop the horizontal hollow cylinder. The tape measure hook accommodating clip includes a first wall and a second wall, the first wall and the second wall are parallel to each other and a slit is formed therebetween. The slit is adapted to accommodate a tape measure hook and a magnetic base of the clip secures the bottom edge of the hook. The cylinder has a first open end and a second open end opposite to the first open end, with a continuous cavity extending along the length of the cylinder between the open ends. The cylinder is adapted for accommodating a marking utensil in a horizontal position enabling a user to utilize the marking utensil for making a mark on a surface.

In yet another embodiment, a tape measure accessory device is disclosed. The tape measure accessory device includes a clip with a slit formed between two parallel generally rectangular walls. The slit is adapted to accommodate a metal hook of a conventional tape measure, wherein the walls of the clip provide additional support to the accommodated hook. The bottom edge of the tape measure hook is magnetically attracted to a magnetic base of the clip to securely retain the hook inside the clip without unintentional detachment of the device when the measuring tape is maneuvered by a user. A horizontal hollow hexagonal cylinder is integrated underneath the clip, wherein a marking utensil is inserted into the cylinder to enable a user to make marks, with a portion of the marking utensil extending out of the cylinder to point toward a surface for making a mark.

In a further embodiment, a tape measure with a marking utensil holder device is disclosed. The tape measure includes a blade, a hook riveted to a free end (i.e., terminal end) of the blade, the marking utensil holder device includes a clip having a slit into which the hook is accommodated, a marking utensil holder component is integrated underneath the clip, the marking utensil holder component holds a marking utensil used for marking a mark at the desired surface location while using the tape measure by an operator.

In still another embodiment of the present invention, the cylinder has a uniform diameter substantially equal to the diameter of a conventional marking utensil for secure retention of the marking utensil without unintentional sliding or tilting from the ends.

In another aspect of the present invention, the length of the first wall and the second wall is substantially equal to the length of a conventional tape measure hook, providing secure accommodation of the tape measure hook in the clip.

Numerous benefits and advantages of this invention will become apparent to those skilled in the art to which it pertains upon reading and understanding the following detailed specifications.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a tape measure marking tool holder device of the present invention in accordance with the disclosed structure;

FIG. 2 illustrates a perspective view of the placement of the tape measure accessory device of the present invention for attaching to the tape measure hook of a tape measure in accordance with the disclosed structure;

FIG. 3 illustrates a perspective view of the tape measure accessory device of FIG. 1 attached to a tape measure hook and holding a marking utensil in accordance with the disclosed architecture;

FIG. 4 illustrates another embodiment of the tape measure accessory device of the present invention in accordance with the disclosed structure; and

FIG. 5 illustrates the tape measure attachment device of FIG. 4 in use for marking a mark on a wall while being used with a tape measure in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a tape measure attachment device that eliminates the need for individuals to carry the pencil separately in their pockets or behind their ear while using a tape measure. Additionally, there is a long-felt need in the art for a tape measure attachment device that can be integrated or detachably attached to a hook of a tape measure. Moreover, there is a long-felt need in the art for a tape measure marking utensil holder device that provides easy accessibility of the marking utensil to an individual working with a tape measure. Further, there is a long-felt need in the art for a tape measure attachment device that makes measurements and markings more efficient and less prone to disruptions. Furthermore, there is a long-felt need in the art for a tape measure accessory device that enables individuals to make markings with ease, even in tight spaces. Finally, there is a long-felt need in the art for a tape measure marking utensil holder device that prevents individuals from accidentally dropping or losing track of their marking utensil.

The present invention, in one exemplary embodiment, is a tape measure with a marking utensil holder device. The tape measure includes a blade, a hook riveted to a free end (i.e., terminal end) of the blade, the marking utensil holder device includes a clip having a slit into which the hook is accommodated, a marking utensil holder component is integrated underneath the clip, the marking utensil holder component holds a marking utensil used for marking a mark at the desired surface while using the tape measure by an operator.

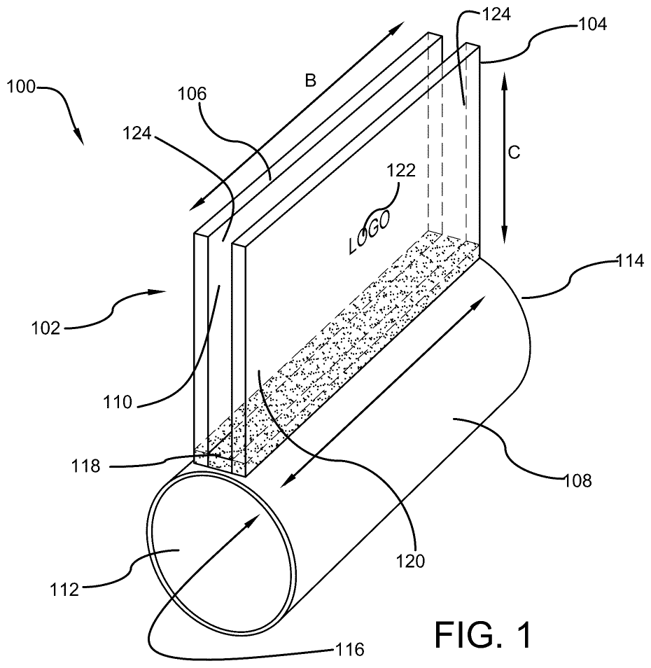

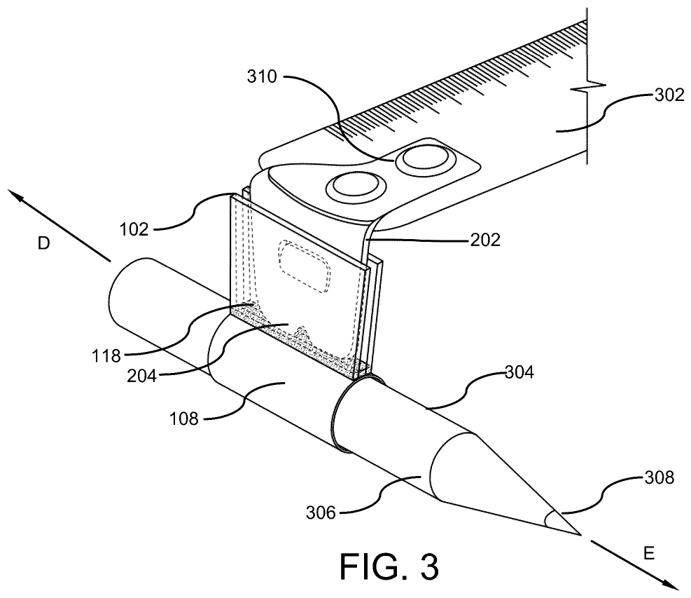

Referring initially to the drawings, FIG. 1 illustrates a perspective view of a tape measure marking tool holder device of the present invention in accordance with the disclosed structure. The tape measure marking tool holder device 100 is designed as a detachably attached attachment for a tape measure hook. The device 100 is used for securing a marking utensil such as a pencil to a tape measure for easy access of the marking utensil to a user of the tape measure. More specifically, the tape measure attachment device 100 is a one-piece construction device that includes a tape measure hook accommodating clip 102. The clip 102 includes a first wall 104 and a second wall 106 parallel to the first wall 104. The first wall 104 and the second wall 106 each are generally rectangular or square and are integrated (i.e., aligned with the tape measure hook) atop a horizontal hollow cylinder 108. The horizontal hollow cylinder 108 is the marking utensil holder component for holding a marking utensil or tool such as a pencil. The clip 102 includes a slit 110 formed between the parallel first wall 104 and the second wall 106 and the slit 110 is adapted to accommodate a tape measure hook therein as illustrated in FIG. 3.

The horizontal hollow cylinder 108 is integrated into the tape measure hook accommodating clip 102. The length (Arrow A) of the cylinder 108 is substantially equal to the breadth or length (Arrow B) of the walls 104, 106. The cylinder 108 has a first open end 112 and a second open end 114 which is opposite to the first open end 112. A continuous cavity 116 extends along the length of the cylinder 108 between the ends 112, 114 and is adapted for accommodating a marking utensil therein in a horizontal position. The device 100 allows a user to use the marking utensil, without separately holding the marking utensil. The cylinder 108 has a uniform diameter (substantially equal to the diameter of a conventional marking utensil) for easily holding a conventional pencil or other marking tool without any unintentional sliding or tilting of the marking utensil from the ends 112, 114.

The base 118 of the clip 102 is magnetic to attract the free end (i.e., terminal end) of a tape measure hook for securing the hook inside the clip 102 as illustrated in FIG. 3. The magnetic base 118 provides a secure holding force for the metal hook of a tape measure. The height of the walls 104, 106 (Arrow C) is substantially equal to the height of a conventional tape measure hook for securely accommodating the hook in the clip 102.

In one embodiment of the present invention, the inner surface 124 of each of the walls 104, 106 can be magnetic to provide additional support to the metal hook of a tape measure. The tape measure accessory device 100 may come in various sizes to accommodate different tape measure models and pencil sizes. Further, the outer surface 120 of one or both the walls 104, 106 can have a logo or any other indicia 122 for branding or marketing purposes.

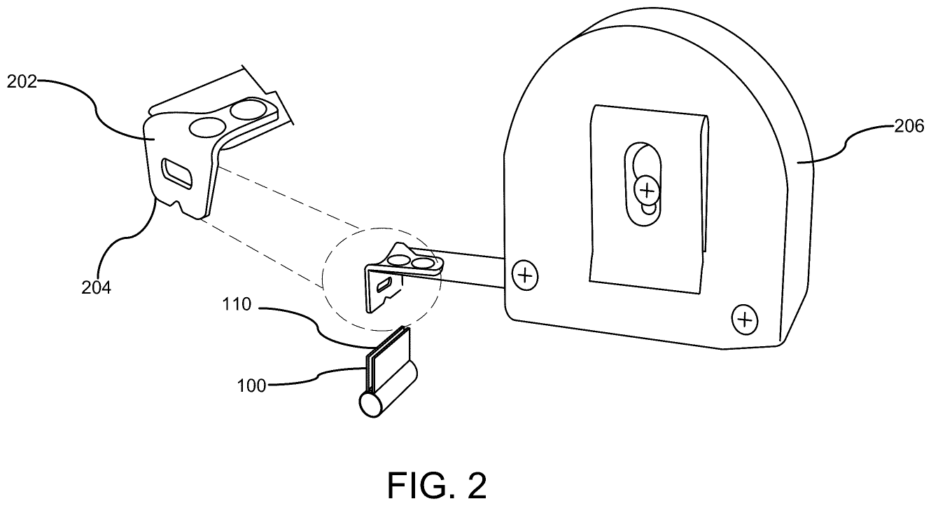

FIG. 2 illustrates a perspective view of the placement of the tape measure accessory device of the present invention for attaching to the tape measure hook of a tape measure in accordance with the disclosed structure. The tape measure accessory device 100 is positioned underneath the bottom edge 204 of the tape hook 202 such that the slit 110 is in coplanar alignment with the hook 202. The tape measure marking tool holder device 100 can be placed on a surface or can alternatively be held in a hand by a user. The hook 202 is inserted in the slit 110 until the bottom edge 204 touches the magnetic base 118 of the clip 102 to secure the hook 202 inside the clip 102. It will be apparent to a person skilled in the art that the device 100 remains secured to the hook 202 and does not fall when the tape measure device 206 is used for measuring dimensions.

FIG. 3 illustrates a perspective view of the tape measure accessory device of FIG. 1 attached to a tape measure hook and holding a marking utensil in accordance with the disclosed architecture. The slit 110 of the clip 102 is designed to accommodate the hook 202 of a conventional tape measure with the walls 104, 106 providing additional support to the accommodated hook 202. The bottom edge 204 magnetically attracts to the base 118 of the clip 102 to secure the hook 202 inside the clip 102. The device 100 can be easily maneuvered by moving the tape measure blade 302 without unintentionally dropping the device 100.

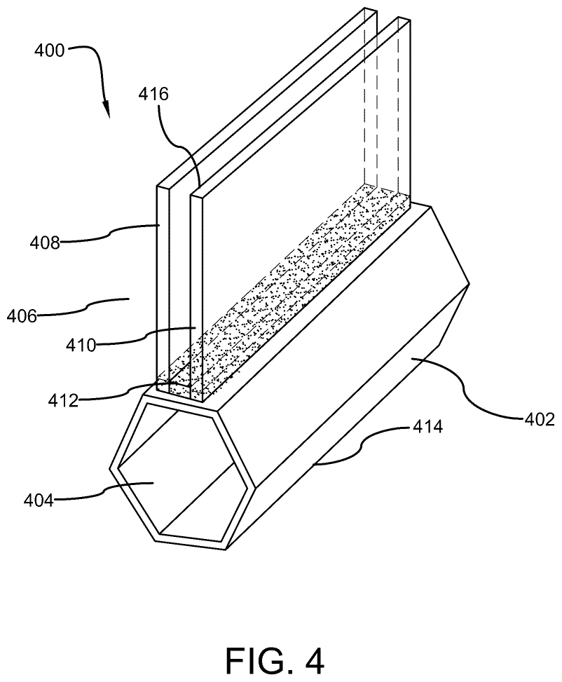

A marking utensil 304 such as a marking pencil is inserted in the horizontal hollow cylinder 108 to enable a user to make a mark easily as illustrated in FIG. 4. A portion 306 of the marking utensil 304 extends out of the cylinder 108 such that the lead or any marking end 308 of the marking utensil 304 easily points to a surface for marking. The cylinder 108 is sized to snugly fit around a portion of the marking utensil 304 without any unintentional sliding or disengagement thereof.

It will be apparent to a person skilled in the art that the hook 202 can be easily pulled from the slit 110 using the riveted end 310 of the hook 202 for detaching the device 100 when is not required for use. Similarly, the marking utensil 304 can be pulled in either direction (Arrows D and E) for removal from the cylinder 108.

FIG. 4 illustrates another embodiment of the tape measure accessory device of the present invention in accordance with the disclosed structure. In the present embodiment, the horizontal hollow hexagonal cylinder 402 has a hexagonal-shaped inner surface 404 for accommodating hexagonal marking pencils or other marking utensils. The clip 406 of the accommodating hook of a tape measure has parallel walls 408, 410 with a magnetic base 412. Further, an eraser storage tab 414 is disposed underneath the cylinder 402 for providing easy accessibility of an eraser to an operator using a tape measure. The mechanism of attaching and removing the device 400 from a tape measure is the same as described in FIGS. 2 and 3 and the hook of a tape measure is accommodated in the slit 416. It should be noted that the cylinder of the tape measure accessory device of the present invention can be made in different shapes (such as a triangular cylinder) to accommodate different types of the marking utensils.

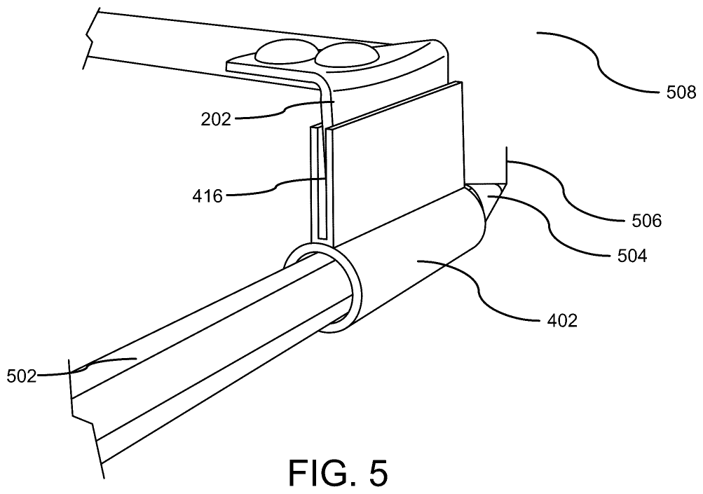

FIG. 5 illustrates the tape measure attachment device of FIG. 4 in use for marking a mark on a wall while being used with a tape measure in accordance with the disclosed structure. As illustrated, a hexagonal pencil 502 is accommodated in the cylinder 402 with the lead or marking end 504 is used for making a mark 506 on a surface 508 such as a wall. The device 400 remains secured to the hook 202 of the tape measure, thus enabling an operator to use the tape measure without requiring accessing a marking utensil from a pocket or the back of the ear.

In some embodiments of the present invention, the base of the clip of the tape measure accessory device 100, 400 is welded to the bottom edge of the hook for integrating the tape measure accessory device to the hook of a tape measure. In other embodiments, fastening means such as a latch or lever may be used for detachably securing the tape measure accessory device to the hook of a tape measure.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “tape measure accessory device”, “tape measure marking tool holder device”, “tape measure attachment device”, and “device” are interchangeable and refer to the tape measure marking tool holder device 100, 400 of the present invention.

Notwithstanding the foregoing, the tape measure marking tool holder device 100, 400 of the present invention can be of any suitable size and configuration as is known in the art without affecting the overall concept of the invention, provided that it accomplishes the above stated objectives. One of ordinary skill in the art will appreciate that the tape measure marking tool holder device 100, 400 as shown in the FIGS. 1-5 are for illustrative purposes only, and that many other sizes and shapes of the tape measure marking tool holder device 100, 400 are well within the scope of the present disclosure. Although the dimensions of the tape measure marking tool holder device 100, 400 are important design parameters for user convenience, the tape measure marking tool holder device 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tape measure marking tool holder device comprising:
a marking tool holder device detachably attached to a tape measure hook for securing a marking utensil;
wherein said marking tool holder having a clip for attaching to the tape measure hook and a hollow cylinder for retaining the marking utensil;
wherein said clip having a first wall and a second wall parallel to said first wall;
wherein said clip having a slit formed between the parallel said first wall and said second wall; and
further wherein said slit accommodating and aligning the tape measure hook therein.

2. The tape measure marking tool holder device of claim 1, wherein said marking tool holder is selectively attached.

3. The tape measure marking tool holder device claim 2, wherein said first wall and said second wall are rectilinear.

4. The tape measure marking tool holder device of claim 3, wherein said hollow cylinder attached below said clip.

5. The tape measure marking tool holder device of claim 4, wherein said hollow cylinder is aligned with the tape measure hook.

6. The tape measure marking tool holder device of claim 5, wherein the marking utensil is a pencil.

7. The tape measure marking tool holder device of claim 1, wherein said hollow cylinder having a first length and said first and said second walls having a second length, and further wherein said first length is equal to said second length.

8. The tape measure marking tool holder device of claim 7, wherein said hollow cylinder having a first open end and an opposing second open end.

9. The tape measure marking tool holder device of claim 8, wherein said hollow cylinder having a continuous cavity extending along said second length from said first open end to said second open end for securing the marking tool in a horizontal position therein.

10. The tape measure marking tool holder device of claim 9, wherein said hollow cylinder having a uniform diameter.

11. The tape measure marking tool holder device of claim 5, wherein said clip having a magnetic base for attracting to a terminal end of the tape measure hook.

12. A tape measure marking tool holder device comprising:
a marking tool holder device detachably attached to a tape measure hook for securing a marking utensil;
wherein said marking tool holder having a clip for attaching to the tape measure hook and a hollow cylinder for retaining the marking utensil;
wherein said clip having a first wall, a second wall, and a magnetic base;
wherein said first wall is parallel to said second wall;
wherein said clip having a slit formed between the parallel said first wall and said second wall;
wherein said slit accommodating the tape measure hook therein; and
further wherein said magnetic base of said clip for attracting to a terminal end of the tape measure hook.

13. The tape measure marking tool holder device of claim 12, wherein said marking tool holder is selectively attached.

14. The tape measure marking tool holder device of claim 13, wherein said first wall and said second wall are rectilinear.

15. The tape measure marking tool holder device of claim 14, wherein said hollow cylinder attached below said clip.

16. The tape measure marking tool holder device of claim 15, wherein said hollow cylinder is aligned with the tape measure hook.

17. The tape measure marking tool holder device of claim 16, wherein said hollow cylinder having a first length and said first and said second walls having a second length, and further wherein said first length is equal to said second length.

18. The tape measure marking tool holder device of claim 17, wherein said hollow cylinder having a continuous cavity extending along said second length from a first open end to a second open end for securing the marking tool in a horizontal position therein.

19. A tape measure marking tool holder device comprising:
a marking tool holder device detachably attached to a tape measure hook for securing a marking utensil;
wherein said marking tool holder having a clip for attaching to the tape measure hook and a hollow cylinder for retaining the marking utensil;
wherein said clip having a first wall, a second wall, and a magnetic base;
wherein said first wall is parallel to said second wall;
wherein at least one of said first wall and said second wall having an interior magnetic surface;
wherein said clip having a slit formed between the parallel said first wall and said second wall;
wherein said slit accommodating the tape measure hook therein; and
further wherein said magnetic base and said interior magnetic surface of said clip for attracting to the tape measure hook.

20. The tape measure marking tool holder device of claim 19, wherein said hollow cylinder is aligned with the tape measure hook for centering the marking tool relative to the tape measure hook.
